(19) United States
(12) Patent Application Publication
(10) Pub. No.: US 2009/0212521 A1
(43) Pub. Date: Aug. 27, 2009

(54) Auxiliary supporting frame for receiving axles of a vehicle

(75) Inventors: Hubertus Steffens, Drolshagen (DE); Sascha Dorner, Reichshof (DE); Frank Weisse, Wenden (DE); Reiner Hielscher, Bergneustadt (DE)

Correspondence Address: HUDAK, SHUNK & FARINE, CO., L.P.A., 2020 FRONT STREET, SUITE 307, CUYAHOGA FALLS, OH, 44221, US

(73) Assignee: Automotive Group ISE Innomotive Systems Europe GMBH, Bergneustadt (DE)

(21) Appl. No.: 11/988,762

(22) PCT Filed: Jul. 17, 2006
(86) PCT No.: PCT/EP2006/007015

§ 371 Date: Feb. 2, 2009

(30) Foreign Application Priority Data
Jul. 17, 2005 (DE) 10 2005 033 814.3

(51) Int. Cl. B62D 21/11

(52) U.S. Cl. 280/124.109

(57) ABSTRACT

An auxiliary supporting frame for receiving drive shafts of a vehicle, wherein the auxiliary supporting frame has longitudinal supporting arms and transverse supporting arms connecting the latter to each other in order to form a closed frame shape, and wherein one or more openings are provided for the passage of drive shafts or shaft sections, and having at least one stiffening sleeve element is arranged in the at least one opening in at least one longitudinal supporting arm or in a section of the auxiliary supporting frame, and the sleeve element is fitted in such a manner into the opening between shells, parts or walls of the at least one longitudinal supporting arm, which is designed as a hollow body, the said shells, parts or walls forming a longitudinal supporting arm, and is fastened in such a manner to the shells, parts or walls of the at least one longitudinal supporting arm that it closes off the opening to the interior of the hollow body in a sealing manner in order to form protection against corrosion, wherein the at least one stiffening sleeve element is connected at least on one side within the at least one opening to the surrounding walls, shells or parts of the at least one longitudinal supporting arm.

### FIELD OF INVENTION

The present invention relates to an auxiliary supporting frame for receiving driveshafts of a vehicle, the auxiliary supporting frame having longitudinal support arms and transverse support arms connecting them to form a closed frame form, one or more openings being provided for the passage of driveshafts or shaft sections, and a device for reinforcing an auxiliary frame for a vehicle for use with such an auxiliary frame.

### BACKGROUND OF THE INVENTION

Auxiliary support frames are known in the prior art in manifold designs. They are used therein, for example, for mounting the drive assembly and/or also as front axle supports. DE 199 20 052 C2 and DE 199 09 945 C1 disclose auxiliary support frames used for mounting a drive assembly, whose transverse girders are fastened from below to longitudinal girders of a vehicle. DD 46 783discloses an auxiliary support frame for a front wheel suspension of front-wheel drive passenger automobiles having a self-supporting vehicle body and lateral shell hollow bodies, which have triangular openings for the passage of the wheel driveshaft and of the steering gear with steering rods.

In the event of use as a front axle support it is possible, inter alia, to use an auxiliary support frame as a pre-mounting module for an engine-transmission unit, axle, steering, torsion bar, a jack receptacle, and shielding. In this way, all elements may already be pre-mounted on the auxiliary support frame before the installation in a vehicle, so that the mounting of the engine-transmission unit, which is otherwise quite complex solely because of the weight, is made significantly easier in particular.

The axles or driveshafts of a vehicle are either passed above or below the auxiliary support frame or they are guided, for example, through two passage openings in the longitudinal girder structure of each side of the auxiliary support frame implemented by two girders led one over another (DE 199 09 945 C1).

Driveshafts situated in the lateral border areas of the auxiliary support frame for connecting wheel and differential also limit, like the drive assembly, the possible component cross-section of the auxiliary support frame. The rigidity of the auxiliary support frame is impaired in this way.

Rigidity problems may also occur in auxiliary support frames which have a U-shape instead of a closed shape. A U-shaped auxiliary support frame is disclosed in DE 103 52 078 A1. The auxiliary support frame according to DE 101 12 932 A1 is also essentially U-shaped. The auxiliary support frame is fastened to the bottom side of the engine compartment to bearing brackets on forward longitudinal girders situated on both sides of a motor vehicle body. The bearing brackets have reinforcement walls, which are to reinforce the closed, curved external surface of the auxiliary support frame. According to EP 1 386 827 A2, a framework-like stiffening of transverse girders of auxiliary support frame with reinforcement walls is also known.

If the rigidity of an auxiliary support frame also requires that the driveshaft cannot be guided around the auxiliary support frame, but rather a hole is to be provided in a lateral edge area thereof, further stability problems arise on the part of the auxiliary support frame, for which there is not yet an optimal solution in the prior art.

### SUMMARY OF THE INVENTION

The present invention is based on the object of refining an auxiliary support frame for receiving driveshafts of a vehicle in such a way that the driveshafts may have an optimal shape and nonetheless an optimal rigidity distribution in the longitudinal direction of the auxiliary support frame is provided for the auxiliary support frame even in the event of passage of at least parts of the driveshaft, to fulfill the requirements for the rigidity of a vehicle in the longitudinal direction without problems. Furthermore, a tight connection is to be provided between the auxiliary support frame, which is implemented at least partially as a hollow body, and the sleeve element, which may securely protect the openings provided in this area for the passage of parts of the driveshaft from corrosion.

The object is achieved for an auxiliary support frame for receiving driveshafts of a vehicle, the auxiliary support frame having longitudinal support arms and transverse support arms connecting them to implement a closed frame form, one or more openings being provided for the passage of driveshafts or shaft sections, in that at least one reinforcing sleeve element is situated in the at least one opening in at least one longitudinal support arm or a section of the auxiliary support frame and the sleeve element is inserted into the opening between shells forming a longitudinal support arm, parts or walls of the at least one longitudinal support arm implemented as a hollow body in such a way, and fastened to the shells, parts, or walls of the at least one longitudinal support arm in such a way that it closes the opening to the interior of the hollow body to form a seal to produce a corrosion protection, it being connected at least on one side within the at least one opening to the surrounding walls, shells, or parts of the at least one longitudinal support arm. For a device for reinforcing an auxiliary frame for a vehicle for use with such an auxiliary frame, it is achieved in that the device is a sleeve element, which is insertable into the auxiliary support frame in openings provided therein for the passage of driveshafts or shaft sections, the sleeve element essentially being implemented as tailored to the dimensions and the geometry of the opening and having a middle part and at least one border bent at an angle at one end of the middle part. Refinements of the present invention are defined in the dependent claims.

An auxiliary support frame is thus provided in which one or more openings for the passage of driveshafts or shaft sections are situated at the points of the longitudinal support arms in the auxiliary support frame which allow an optimum course of the driveshafts, the driveshafts being inserted at least partially through the auxiliary support frame. Simultaneously, to produce sufficient rigidity of the support frame, the particular opening is provided with a sleeve element which is fitted in the opening. Particularly in comparison to the prior art of DE 199 09 945 C1, a design requiring fewer parts is provided by the provision of an opening directly in the longitudinal support arm of the auxiliary support frame. The two girders enclosing a passage opening for the driveshaft are no longer required, but rather only the provision of one or more openings in the auxiliary support frame. Instead of manufacturing additional parts, such as the girders, the longitudinal support arms are only still subjected to a punching procedure after the shaping procedure, for example, to implement the opening(s). The number of individual parts of the auxiliary support frame to be manufactured may thus be minimized.

Furthermore, by providing at least one sleeve element in the at least one opening in the auxiliary support frame, reinforcement of the auxiliary support frame itself is possible in relation to merely providing the openings in the auxiliary support frame to improve the shape of the driveshafts. The weakening of the auxiliary support frame by the opening(s) may advantageously be compensated for in this way. The auxiliary support frame thus has, in spite of providing openings which weaken its structure, an undiminished rigidity and strength. Two advantages, the advantage of an optimum shape and guiding of the driveshafts and the advantage of optimal stability and rigidity of the auxiliary support frame, may thus be implemented together.

DE 699 22 711 T2 does disclose a frame rear structure for vehicles having driving rear wheels, in which a first and a second opening are provided in lateral frame parts of the frame structure. The first and second openings are each situated in the middle sections of the frame structure. However, this does not represent a real auxiliary frame, but rather the actual frame structure of a vehicle. A tubular reinforcement sleeve is inserted into the periphery of the openings to improve the strength therein. The reinforcement sleeve is cylindrical and projects beyond the lateral extension of the frame structure. In contrast thereto, the sleeve element according to the present invention is connected inside the opening in the longitudinal support arms of the auxiliary support frame to their walls or parts forming them. The sleeve element thus does not project beyond the external extension of the longitudinal support arm, so that the connection point(s) between sleeve element and longitudinal arm is/are better protected from impingement by moisture.

The sleeve element is advantageously implemented as tailored to the geometry and/or dimensions of the at least one opening in the auxiliary support frame. The sleeve element is preferably inserted in a formfitting way into the opening and removably or permanently fastened inside the opening. The sleeve element may thus absorb forces especially well by its optimal fitting in the opening(s) provided in the auxiliary support frame and thus contribute to the rigidity structure of the auxiliary support frame. The rigidity loss of the auxiliary support frame caused by cutting out the opening(s) may thus be compensated for especially well. The fastening of the sleeve element in the opening in the auxiliary support frame may be performed by welding or soldering or another fastening method, also such as a flanging procedure, for example. A fastening method in which a sealed bond. is possible between the auxiliary support frame, in particular its longitudinal support arm shell, and the sleeve element has been proven to be especially advantageous, because in this way corrosion protection for the interior of the auxiliary support frame and/or its longitudinal support arm is possible in particular. The sleeve element thus also fulfills, in addition to the tasks already cited, a corrosion protection function for the auxiliary support frame in the area of the opening, into which it is introduced. By providing such an opening in the auxiliary support frame, which is constructed as a hollow body and/or shell, in particular its longitudinal support arms, otherwise water may penetrate into the interior of the auxiliary support frame. Because of the partially very complex shape of the auxiliary support frame, which is provided with numerous undercuts, this water, which is, for example, thrown up from the road during the travel of a vehicle as sprayed water, mixed with scattered salt in winter, cannot leave the auxiliary support frame again independently, in spite of the possibly increased temperatures in the engine compartment of the vehicle. By the advantageous introduction of the sleeve element in such a way that a good seal of the interior of the auxiliary support frame hollow body is possible, the sleeve element may be used as corrosion protection means and reinforcement.

The sleeve element preferably extends, in the area of the opening, at least partially on the interior or exterior side of walls enclosing a longitudinal support arm and/or the shell of the longitudinal support arm. The sleeve element may rest on the exterior side of the shell or an external wall of the longitudinal support arm, so that a connection which seals the opening may be provided easily here, a connection also being able to be produced easily by welding if it rests on the interior side of the wall(s). The sleeve element advantageously has a middle part, which is particularly essentially cylindrical, and a border bent at an angle from the middle part on at least one end. The border may be implemented to rest on the exterior or interior side of the wall or shell of the longitudinal support arm.

Additionally or alternatively, the wall or shell parts of the at least one longitudinal support arm enclosing the at least one opening may be bent over in the direction toward the sleeve element to provide a sealed attachment on the sleeve element. This bending over of the area enclosing the opening in the plate and/or the wall and/or the shell of the longitudinal support arm is preferably implemented in such a way that a good attachment and thus a sealed connection to the sleeve element are possible. Because butt welding of a linear end of an essentially cylindrical section of the sleeve element may again be executed easily, because the two edges to be connected of the opening and the sleeve element are largely approximately perpendicular to one another, and also results without problems in a well sealing connection, bending over the border of the shell or the wall of the longitudinal support arm enclosing the opening proves to be especially advantageous.

In addition to the implementation of the sleeve element resting on at least one side on the exterior side of the longitudinal support arm, it may also be inserted between parts forming a longitudinal support arm or between walls of the at least one longitudinal support arm implemented as a hollow body. Providing bent-over or projecting borders on both ends of the sleeve element is suitable here. They are preferably tailored in such way that they press against the interior sides of the walls or shells of the longitudinal support arm, so that again a sealed connection may be provided between walls and/or shells and the sleeve element.

Furthermore, a first section, which encloses the opening, of the shell forming a longitudinal support arm, parts or walls of the at least one longitudinal support arm implemented as a hollow body may be implemented as tapering conically into the opening, the sleeve element then preferably being connected inside the opening to the conically tapering first section. By providing a first section conically tapering into the opening, the exit surface may be significantly reinforced. Furthermore, a weld seam for connecting sleeve element and first section may be laid optimally in regard to the strength of the connection, positioning in a lower-stress area in the interior of the opening being possible, and in regard to the good accessibility of the weld seam, easier joining of the parts to be connected before the welding additionally being possible.

Alternatively or additionally, a second section, which encloses the opening, of the shell forming a longitudinal support arm, parts or walls of the at least one longitudinal support arm implemented as a hollow body may be drawn into the opening, the sleeve element preferably being connected to the second section at the border bent at an angle. In this way, numerous variants of a connection of the sleeve element and the walls of the longitudinal support arm are possible, which allow optimum adaptation to the particular shaping of the longitudinal support arms and of the auxiliary frame. The sleeve element may be implemented as rotationally symmetric or asymmetric, and may have an uneven length over its longitudinal section.

The sleeve element may be implemented either in one piece or multiple pieces. The one-piece form is suitable, for example, upon insertion of the sleeve element between the walls or shells of the longitudinal support arm, but also for one-sided resting of a border bent over at the end or a bent-over rim on the exterior side of the wall or shell of the longitudinal support arm. A multipart form may also be used here, however, particularly if adaptation to the opening shape is thus more easily possible. A multipart form is used above all when the sleeve element is provided at both ends with a bent-over border or a bent-over rim, which is to be joined on the exterior sides of the walls or shells of the longitudinal support arm, because this is much easier to perform with a multipart form.

The sleeve element is preferably implemented as a deep-drawn part. It is thus possible to bring the sleeve element into the desired shape especially easily. The sleeve element may have a round or oval cross-section. Fundamentally, however, a polygonal and arbitrary cross-section of the sleeve element is also possible. The sleeve element is advantageously drawn out of a flat sheet-metal plate. The length and shape of the sleeve element may be tailored individually to a particular application using a corresponding deep-drawing tool, i.e., to the geometry required for a particular longitudinal support arm, no reworking being necessary after the reshaping procedure. Both the cross-section and also the length and also the bent-over border of the sleeve element may be prepared in one deep-drawing procedure in the desired shape without reworking. The degree of the bending of the border or borders of the sleeve element may be tailored to the conditions of the mounting sequence of the sleeve element and the remaining parts of the auxiliary frame, so that self-centering and high fit precision in regard to the longitudinal support arm may be achieved for the sleeve element.

The sleeve element advantageously has at least one recess area in the middle part extending from one end of the sleeve element in the direction toward the other end. By providing such a recess area, the driveshaft may rest better in the opening and/or may be guided more steeply out of it or clearance for other components or assemblies is provided in this way. Such a recess area is preferably tailored to the particular shaping of the driveshaft and may also be left out if it is not required.

The recess area is advantageously delimited by a bent-over border. This may also be laid on the wall(s) or shell(s) enclosing the opening and fastened thereto to form a seal. The recess area usually only extends from one end of the sleeve element. It is usually situated on the side of the auxiliary support frame directed inward to the inner chamber enclosed by the longitudinal support arm and the transverse support arm, because the driveshafts are guided upward here if needed, so that providing the recess area here has been proven to be advantageous.

The sleeve element encloses a driveshaft or parts thereof and does not have any sharp-edged areas at least in the area enclosing the driveshaft, so that a collar of the driveshaft which is situated in the area of the passage through the longitudinal support arm of the auxiliary support frame may advantageously be protected from damage. This protection cannot be achieved by the auxiliary support frames of the prior art, because they are usually constructed from diverse curved shell parts having sharp-edged edges precisely in the area of the passage of driveshafts, on which a collar enclosing the driveshaft which is inserted through may be damaged.

### BRIEF DESCRIPTION OF THE DRAWINGS

In the following, exemplary embodiments of the present invention are described in greater detail on the basis of the drawings to explain the present invention in greater detail.

FIG. 1 shows a perspective outline view of a vehicle having an auxiliary support frame, which is implemented according to the present invention, installed at the front,

FIG. 2 shows a perspective view of the auxiliary support frame from FIG. 1 having sleeve elements according to the present invention inserted into openings in the longitudinal support arms of the auxiliary support frame,

FIG. 3 shows a perspective view of a first embodiment of the sleeve element according to the present invention as it is installed in the auxiliary support frame from FIG. 2,

FIG. 4 shows a detail sectional view of the sleeve element from FIG. 3, installed in an auxiliary support frame,

FIG. 5 shows a sectional view of the sleeve element from FIG. 3,

FIG. 6 shows a perspective view of a second embodiment of a sleeve element according to the present invention,

FIG. 7 shows a detail sectional view of the sleeve element from FIG. 6, installed in an auxiliary support frame,

FIG. 8 shows a sectional view of the sleeve element from FIG. 6,

FIG. 9 shows a lateral sectional view of a third embodiment of a sleeve element according to the present invention, and

FIG. 10 shows a lateral sectional view of fourth embodiment of a sleeve element according to the present invention.

### DETAILED DESCRIPTION OF THE INVENTION

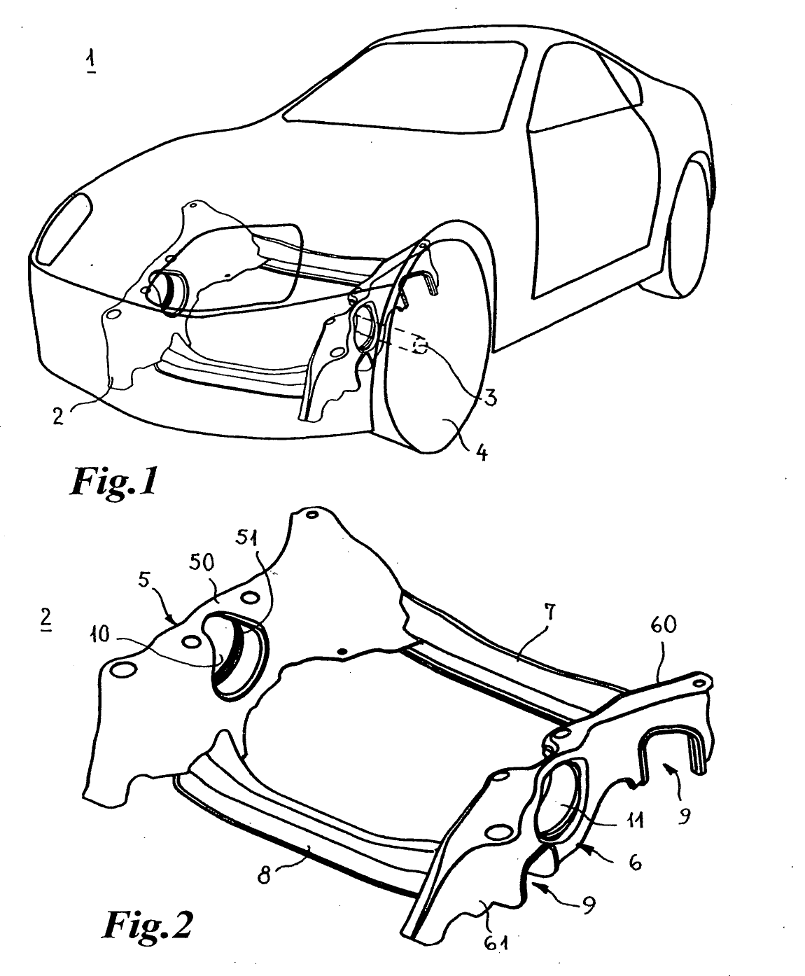

FIG. 1 shows a perspective view of a vehicle 1 having an auxiliary support frame 2 installed at the front for receiving driveshafts 3 (only indicated) of the vehicle for driving the wheels 4. The auxiliary support frame 2 has two longitudinal support arms 5, 6 running approximately parallel and transverse support arms 7, 8 connecting them to implement a closed frame form, as may be inferred better from the view in FIG. 2.

The transverse support arms 7, 8 are implemented as tunnel-shaped, having openings 9 directed downward. Shafts or other parts may be guided into the engine compartment of the vehicle through these tunnel-shaped openings. The longitudinal support arms 5, 6 are implemented as hollow bodies which are constructed from molded shell parts 50, 51, 60, 61, which are connected to one another. Shell parts are also provided on the bottom side of the longitudinal support arms, which are not visible in FIG. 2, however. The closed hollow body of the longitudinal support arms is thus formed.

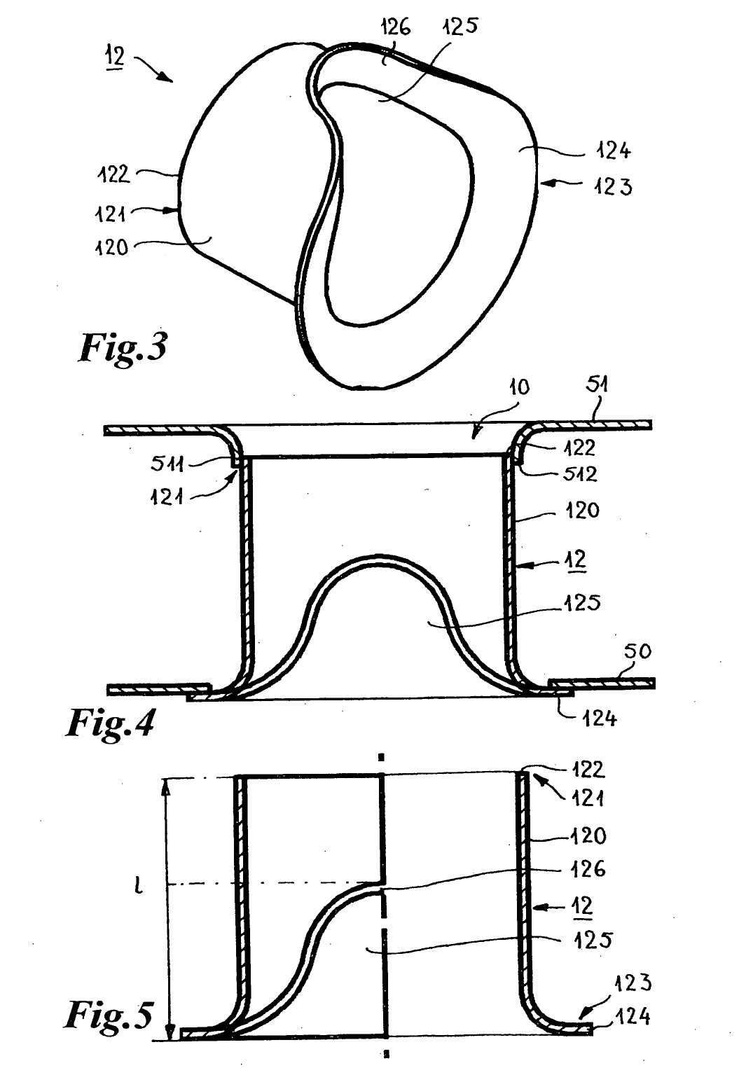

The shell parts are each provided with openings 9, 10, 11. The hollow body of the shell of the longitudinal support arms is opened to the outside again by the openings 10, 11. A driveshaft inserted through the openings 10, 11 and/or a collar enclosing it may be damaged by the sharp-edged plates. Furthermore, the penetration of liquid into the particular hollow body of the two longitudinal support arms is possible, so that corrosion may occur inside the longitudinal support arms. Therefore, sleeve elements, as are shown in FIGS. 3 through 8, are inserted into the two openings 10, 11, which are seated in a formfitting way in the openings 10, 11. In this way, protection of the collars and/or the driveshaft from damage by sharp edges in the area of the openings and protection of the longitudinal support arm hollow bodies from corrosion are possible, because the sleeve elements allow a connection between the shell parts 50, 51 and 60, 61.

A first embodiment of a sleeve element 12 is shown in FIG. 3. The sleeve element 12 has a cylindrical middle part 120, a linear edge 122 on its first end 121 and a border 124 bent over at an angle on its second end 123. Furthermore, a recess area 125 is formed, which is shaped like a spout and is enclosed by a bent-over border 126, and which extends from the second end 123 in the direction toward the first end 121. The recess area is used for receiving driveshaft parts projecting upward out of the auxiliary support frame or also as clearance for other components and assemblies. Especially optimum shaping of the driveshafts is thus possible, because an adaptation to their shaping is possible by the implementation of the openings 10, 11 and the sleeve elements. By providing a bent-over border 126, which is in one piece with the bent-over border 124 and passes into it, the protection of the driveshafts and also sealing of the openings 10, 11 in the recess area may occur. The bent-over borders rest in the openings 10, 11 in such a way that after the sheets of the shell parts and the sleeve elements are welded to one another, for example, a good seal of the interior of the longitudinal support arm hollow body against penetration of moisture may be generated.

As may be inferred better from the sectional views in FIGS. 4 and 5, the recess area 125 extends over approximately half of the length l of the sleeve element 12. The dimensions of the recess area 125 may be selected as a function of the particular application.

To also obtain a sealed attachment to the sleeve element 12 in the area of its first end 121, the shell part 51 has a bent-over border 511 enclosing the opening 10. This border extends in the direction toward the sleeve element 12 and/or its first end 121. The first end 121 of the sleeve element, which ends there with the linear edge 122, is situated on the interior side of the bent-over border 511, somewhat overlapping its front edge 512. The sleeve element and the bent-over edge of the shell part 51 are connected to one another to form a seal by welding or soldering, for example. The bent-over border 124 at the other end 123 of the sleeve element 12 rests on the exterior side of the shell part 50 and also somewhat overlaps it in the area of the opening, so that a well-sealing connection is also possible there, the two plates of the sleeve element and the shell part also being connected there by welding or soldering, for example.

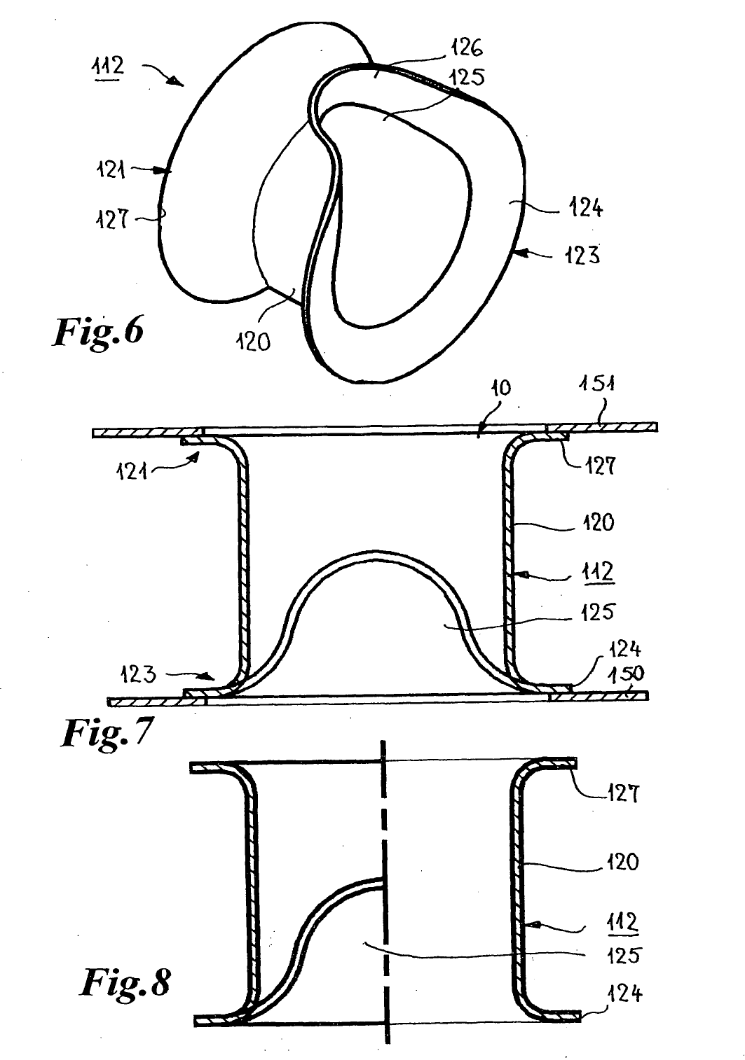

Instead of the one-piece form of the sleeve element from FIGS. 3 through 5, a multipart form may also be selected. Instead of providing one end with a linear edge and another end with a bent-over border, both ends may also have bent-over border, as is shown in the embodiment from FIGS. 6 through 8. The sleeve element 112 according to these figures also has a bent-over border 127 instead of the linear edge 122 on the first end 121 of the sleeve element.

By providing bent-over borders on both ends of the sleeve element, it is situated inside the hollow body of the longitudinal support arm, for example, as shown in FIG. 7, i.e., between the two shell parts 150, 151. The bent-over borders of the sleeve element are mounted on a border area of the shell parts in the area of the opening 10. The amount of the overlap is advantageously selected, as already noted for FIG. 4, in such a way that on one hand a good hold of the sleeve element on the shell parts and, on the other hand, a good seal after the welding, soldering, etc. of the parts are provided. With a two-part or multipart form of the sleeve element, its bent-over borders may also be situated on the exterior side of the shell parts of the longitudinal girders.

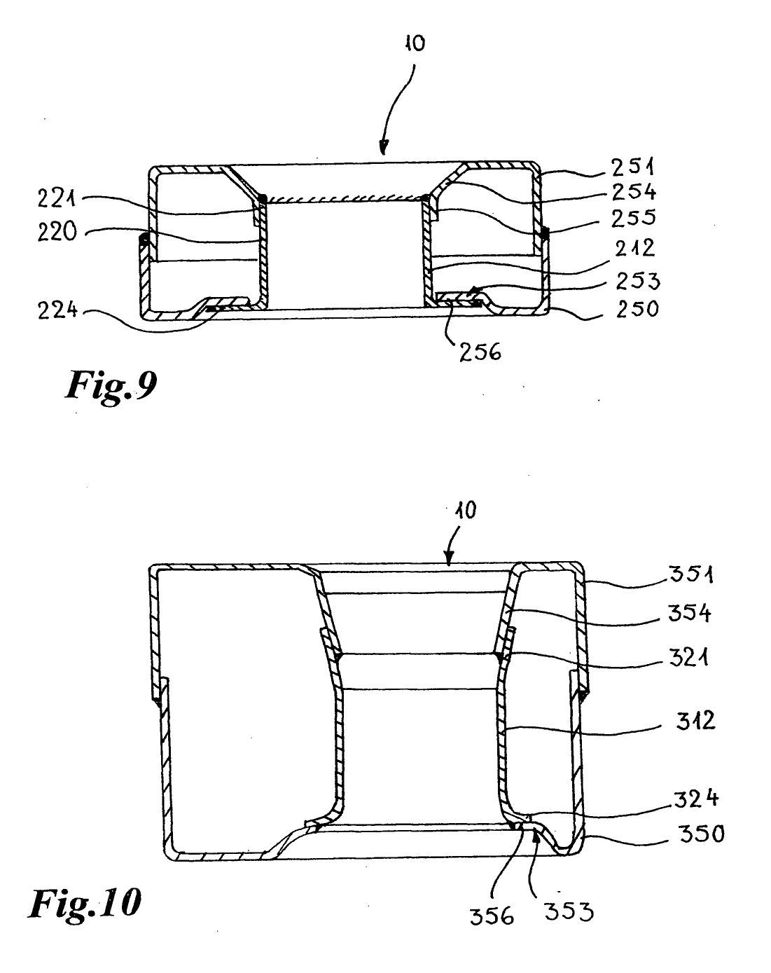

FIG. 9 shows a third embodiment of the sleeve element according to the present invention. The sleeve element 212 is inserted into the opening 10 inside the two shell parts 250, 251, which are connected to one another. The shell part 250 has an indrawn section 253 enclosing the opening 12, and the shell part 251 has a section 254 conically tapering into the interior of the opening. The conical section 254 ends in an approximately cylindrical section 255. The sleeve element 212 has an essentially cylindrical middle part 220 having a first end 221 and a border 224 bent over at approximately a 90° angle. The sleeve element 212 is connected at its end 221 to the cylindrical section on its side facing toward the interior of the opening and to the indrawn section 253 via the bent-over border 224. The border and an end section 256 of the indrawn section 253 rest one on the other. The connection between sleeve element and shell parts is provided by welding, the weld seam points obviously being positioned so they are very well accessible. The sleeve element is also inserted on one side into the opening 10 and welded there. Instead of a regular cross-section, shell parts and sleeve element may also have an irregular cross-section.

A further alternative embodiment of a sleeve element according to the present invention is shown in FIG. 10. The sleeve element 312 is again inserted into the opening 10 inside two shell parts 350, 351. The opening is situated off center in the shell parts. The shaping of the shell parts otherwise essentially corresponds to that of the shell parts 250, 251. In contrast to the embodiment in FIG. 9, the sleeve element 312 has a conical border section 321, however, which is connected to a conical section 354 of the shell element 351. The conical section 354 is situated on the side of the conical edge section 321 pointing into the interior of the opening. A bent-over border 324 of the sleeve element is situated, in contrast to the embodiment in FIG. 9, on the interior side of an end section 356 of an indrawn section 353 of the shell element 350. Sleeve element and shell parts are also connected here by welding, for example, the welded points again being externally accessible well, but still protected from corrosion because of their positioning. It is obvious from FIG. 10 that the welded area may also be implemented conically.

The configuration possibilities of sleeve elements shown and described for the longitudinal support arm 5 also apply correspondingly for the opening 11 in the longitudinal support arm 6 and its shell parts 60, 61. Furthermore, recess areas may also be provided in FIGS. 9 and 10.

Therefore, shielding and/or sealing of the cavity provided inside the longitudinal support arm may be provided by the closed shape of the sleeve element, so that penetration of moisture may be avoided there. In addition to reinforcement of the auxiliary support frame, a seal and thus protection from corrosion for the auxiliary support frame are thus provided by the sleeve element. Furthermore, minimization of the parts used in relation to the prior art is possible, because only the shell parts of the longitudinal support arms and the transverse support arm and the sleeve element have to be provided to implement a sufficiently rigid and thus stable auxiliary support frame. Further reinforcing elements are not required in the area of the longitudinal support arms or the openings provided therein.

In addition to the embodiments of auxiliary support frames having sleeve elements inserted into openings therein and/or such sleeve elements described above and illustrated in figures, numerous further embodiments may be provided. The auxiliary support frame may be implemented as not only suitable for installation in the front area of a vehicle, but rather also for installation in the rear area of a vehicle, for example. Furthermore, the sleeve element may also have a shape different than that described and/or a different shape of a projecting border or a rim. The borders shown projecting approximately perpendicularly from the middle part of the sleeve element in the figures may also project at another angle therefrom, e.g., only 45°, if the borders may then rest better on the external faces and/or internal faces of the longitudinal support arms or, if provided at another point, on the auxiliary support frame.

### LIST OF REFERENCE NUMERALS

1 vehicle
2 auxiliary support frame
3 driveshaft
4 wheel
5 longitudinal support arm
6 longitudinal support arm
7 transverse support arm
8 transverse support arm
9 opening
10 opening
11 opening
12 sleeve element
50 shell part
51 shell part
60 shell part
61 shell part
112 sleeve element
120 cylindrical middle part
121 first end
122 linearedge
123 second end
124 bent-over border
125 recess areas
126 bent-over border
127 bent-over border
150 shell part
151 shell part
212 sleeve element
220 cylindrical middle part
221 end
224 bent-over border
250 shell part
251 shell part
253 indrawn section
254 conically tapering section
255 cylindrical section
256 end section
312 sleeve element
321 conical border section
324 bent-over border
350 shell part
351 shell part
353 indrawn section
354 conical section
356 end section
511 bent-over border
512 front edge
l length of the sleeve element

What is claimed is:

1. An auxiliary support frame for receiving driveshafts of a vehicle, the auxiliary support frame comprising: longitudinal support arms and transverse support arms connecting them to implement a closed frame form, one or more openings being provided for the passage of driveshafts or shaft sections, wherein at least one reinforcing sleeve element is situated in the at least one opening in at least one longitudinal support arm or a section of the auxiliary support frame, and the sleeve element is inserted into the opening between a shell forming the longitudinal support arm, parts or walls of the at least one longitudinal support arm implemented as a hollow body in such a way and is fastened to the shells, parts, or walls of the at least one longitudinal support arm in such a way that it closes the opening to the interior of the hollow body to form a seal to form a corrosion protection, the at least one sleeve element being connected on at least one side within the at least one opening to the surrounding walls, shells, or parts of the at least one longitudinal support arm.

2. The auxiliary support frame according to claim 1, wherein the sleeve element is implemented as tailored to the geometry or dimensions or a combination thereof of the at least one opening.

3. The auxiliary support frame according to claim 1, wherein the sleeve element is inserted in a formfitting way into the opening and is removably or permanently fastened inside the opening.

4. The auxiliary support frame according to claim 3, wherein the sleeve element is welded or soldered into the opening.

5. The auxiliary support frame according to claim 1, wherein the sleeve element is implemented in one piece.

6. The auxiliary support frame according to claim 1, wherein the sleeve element is implemented in multiple parts.

7. The auxiliary support frame according to claim 1, wherein a first section, which encloses the opening, of the shell forming a longitudinal arm, parts, or walls of the at least one longitudinal arm implemented as a hollow body is implemented as tapering conically into the opening.

8. The auxiliary support frame according to claim 7, wherein the sleeve element is connected to the conically tapering first section inside the opening.

9. The auxiliary support frame according to claim 1, wherein a second section, which encloses the opening, of the shell forming a longitudinal support arm, parts, or walls of the at least one longitudinal support arm implemented as a hollow body is drawn into the opening.

10. The auxiliary support frame according to claim 9, wherein the sleeve element has a border bent over at an angle, using which it is connected to the second section.

11. The auxiliary support frame according to claim 1, wherein the sleeve element extends on the interior or exterior side of walls forming a longitudinal arm in the area of the opening.

12. The auxiliary support frame according to claim 1, wherein the sleeve element is implemented as a deep-drawn part.

13. The auxiliary support frame according to claim 1, wherein the sleeve element has a round or oval cross-section.

14. A device for reinforcing an auxiliary support frame for a vehicle for use with an auxiliary support frame, comprising: a sleeve element, which is adapted to be insertable into the auxiliary support frame in openings provided therein for the passage of driveshafts or shaft sections, the sleeve element being implemented as essentially tailored to the dimensions and the geometry of the opening and having a middle part and a border bent over at an angle from the middle part on at least one end.

15. The device according to claim 14, wherein the sleeve element has at least one border bent over approximately at a right angle.

16. The device according to claim 14, wherein the sleeve element has at least one section opening conically outward.

17. The device according to claim 14, wherein the sleeve element has at least one recess area in the middle part, extending from one end of the sleeve element in the direction toward the other end.

18. The device according to claim 17, wherein the recess area is enclosed by a bent-over border.

19. The device according to claim 17, wherein the recess area only extends from one end of the sleeve element.
